(19) United States
(12) Patent Application Publication
(10) Pub. No.: US 2014/0059170 A1
(43) Pub. Date: Feb. 27, 2014

(54) PACKET PROCESSING OF DATA USING MULTIPLE MEDIA ACCESS CONTROLLERS

(71) Applicants: Iosif Gasparakis, Shannon (IE); Peter P. Waskiewicz, JR., Hillsboro, OR (US); Ilango S. Ganga, Cupertino, CA (US); Terry V. Hulett, Austin, TX (US); Parathasarathy Sarangam, Portland, OR (US)

(72) Inventors: Iosif Gasparakis, Shannon (IE); Peter P. Waskiewicz, JR., Hillsboro, OR (US); Ilango S. Ganga, Cupertino, CA (US); Terry V. Hulett, Austin, TX (US); Parathasarathy Sarangam, Portland, OR (US)

(21) Appl. No.: 13/976,460

(22) PCT Filed: May 2, 2012
(86) PCT No.: PCT/US12/36108

§ 371 Date: Jun. 26, 2013

(51) Int. Cl. H04L 29/08

(52) U.S. Cl. CPC H04L 67/02
USPC 709/217

(57) ABSTRACT

Examples are disclosed for a device having at least two media access controllers. In some examples, a first media access controller may be coupled to a host computing device. A second media access controller may be coupled to one or more processor circuits arranged to perform packet processing of data payloads for one or more data frames forwarded through the first media access controller and/or forwarded through the second media access controller. The first media access controller may be coupled to the second media access controller via a communication link. Other examples are described and claimed.

### BACKGROUND

Hosting services often referred to as “cloud computing” may provide software, storage and computing infrastructure services over interconnected networks such as the Internet. In some instances cloud service providers host tenants in data centers or server farms. These data centers or server farms may include a large number of computing platforms or host computing devices that may allow tenants to have a number of software instances running on or supported by one or more host computing devices. In some cloud architectures, a single server or host computing device may host multiple tenants in Virtual Machines (VMs) implemented using one or more processors and other computing resources maintained on the host computing device.

### BRIEF DESCRIPTION OF THE DRAWINGS

FIG. 1 illustrates an example first system.

FIG. 2 illustrates an example second system.

FIG. 3 illustrates a block diagram of an example architecture for a data manager.

FIG. 4 illustrates an example third system.

FIG. 5 illustrates an example first process.

FIG. 6 illustrates an example second process.

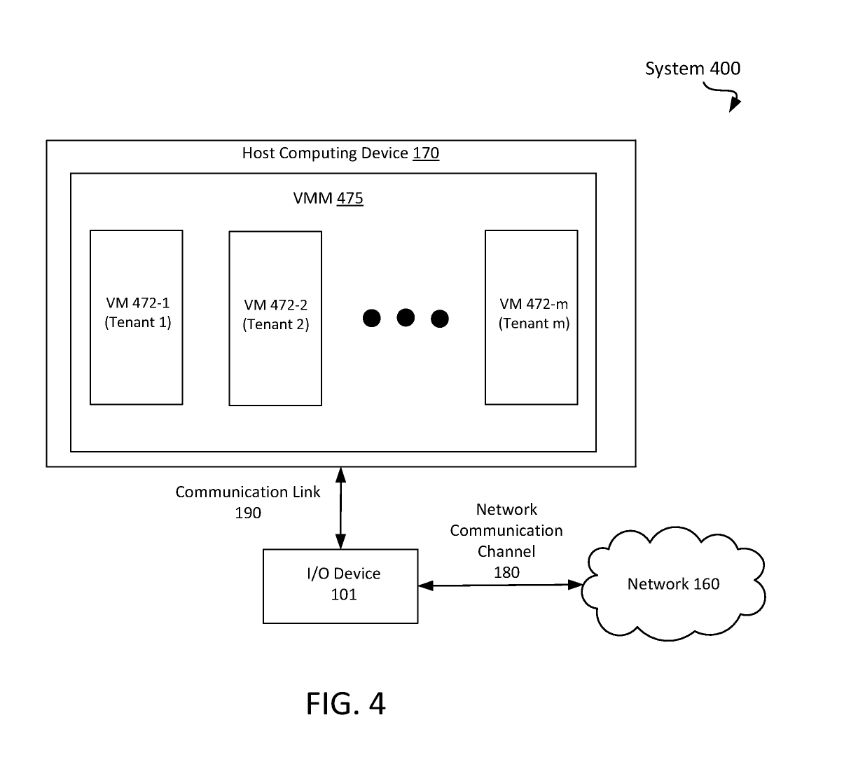

FIG. 4 illustrates an example third process.

FIG. 4 illustrates an example fourth process.

FIG. 7 illustrates an example flow diagram for receiving a data frame from a host computing device.

FIG. 8 illustrates an example flow diagram for receiving a data frame via a network communication channel.

### DETAILED DESCRIPTION

As contemplated in the present disclosure, in some cloud architectures, a single server or host computing device may host multiple tenants in Virtual Machines (VMs) implemented using one or more processors or other computing resources maintained on the host computing device. In some examples, cloud service providers may have to provision, isolate and meter (for billing) resources used by various tenants. The cloud service providers may provide at least some of these services by creating virtual networks that overlay a physical network. For these examples, the virtual networks may be accomplished through software components within a hypervisor or virtual machine manager (VMM) that is typically owned and managed by the cloud service providers.

Several drawbacks may result from maintaining software components to create a virtual network at a host computing device that overlays a physical network. For example, software modules used for this purpose consume a considerable amount of computing resources as they are in a data path for data received or forwarded to tenants. Also, cloud service providers may not be able to take advantage of such schemes with single root input/output (I/O) virtualization (SR-IOV) that allows a VM to bypass a VMM. Further, due to the nature of network packet formats (e.g., tunnel formats) used to support a virtual network, existing network interface card (NIC) based packet processing offloads may not be practical given a possibly wide variety of and sometimes proprietary tunnel formats. NIC-based packet processing offloads may not be possible because most existing network packet processing offloads are based on non-tunneled packets.

Other drawbacks are related to cloud service providers treating monitoring, isolation and metering software as their key know-how and resist or refuse to disclose this knowledge. This resistance or refusal to disclose monitoring, isolation and metering software makes it difficult for manufacturers of network I/O devices such as NICs to design a more efficient I/O device to work in a cloud computing environment. Also, as mentioned previously, maintaining virtual networks at the VMM uses a large amount of computing resources. Using a large amount of computing resources results in less computing resources for cloud service providers to provide to their tenants.

Example devices are disclosed that include multiple media access controllers for packet processing of data received at or transmitted from an I/O device coupled between a host computing device and a network. The example devices may include one or more processor circuits configured to perform packet processing of data forwarded to or from the host computing device. The example devices may also include a first media access controller coupled to the one or more processor circuits and also coupled to a network communication channel. The example devices may also include a second media access controller coupled to the host computing device and a communication link to couple the first media access controller to the second media access controller.

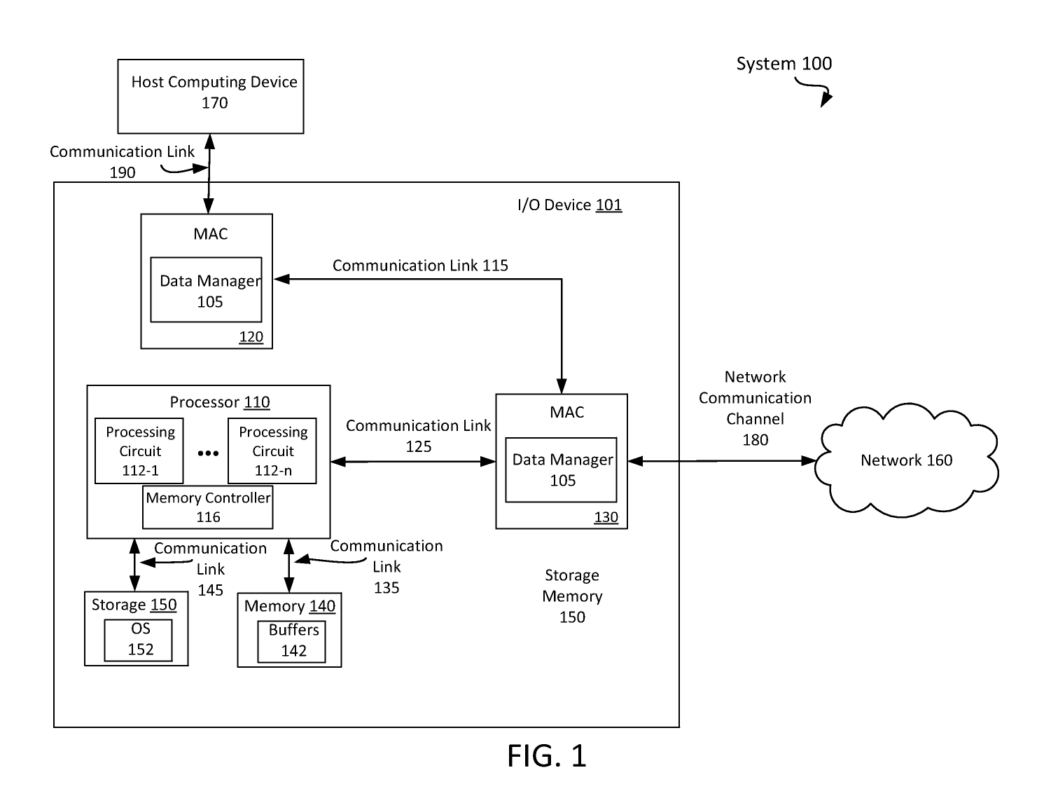

FIG. 1 illustrates an example first system. As shown in FIG. 1, the first system is depicted as system 100. In some examples, system 100 may include an input/output (I/O) device 101 coupled to a network 160 via network communication channel 180 and a host computing device 170 via a communication link 190. Also, as shown in FIG. 1, I/O device 101 includes a processor 110, media access controller (MAC) 120, media access controller (MAC) 130, memory 140 and storage 150. As shown in FIG. 1, communication links 115, 125, 135 and 145 interconnect or couple various elements of I/O device 101 together. This disclosure is not limited to the number, type or arrangement of elements shown in FIG. 1.

According to some examples, as shown in FIG. 1, both MAC 120 and MAC 130 may include a data manager 105. As described more below, data manager 105 may include logic and/or features to enable these media access controllers to receive, forward or transmit data. The data, for example, may be in the format of data packets or data frames received either from network 160 or from host computing device 170. In some examples, MAC 120, MAC 130 and/or data manager 105 may be configured or arranged to operate according to various industry standards or specifications such as the various Ethernet specifications promulgated by the Institute of Electrical and Electronics Engineers (IEEE). For example, one such Ethernet specification (including progenies and variants) may be IEEE 802.3-2008, Carrier sense Multiple access with Collision Detection (CSMA/CD) Access Method and Physical Layer Specifications, Published in December 2008 (hereinafter “IEEE 802.3”). Although two media access controllers are shown in FIG. 1, this disclosure contemplates any number of media access controllers to couple to a host computing device and/or a network.

In some examples, MAC 120 may appear to function, from the perspective of host computing device 170, as a I/O device for coupling host computing device 170 to network 160. Meanwhile MAC 130 may appear to function, from the perspective of network 160, as the I/O device for host computing device 170. In other words, both host computing device 170 and network 160 may not be aware that data received at I/O device 101 is being routed between the various elements of I/O device 101 (e.g., to/from processor 110) before the data egresses from I/O device 101.

In some examples, as shown in FIG. 1, processor 110 includes processor circuits 112-1 to 112-n (where “n” represent any positive integer≧1), and a memory controller 114. As mentioned more below, processor circuits 112-1 to 112-n may be configured or arranged to implement an operating system that may be configured or arranged to support a software service. The software service may be capable of performing packet processing (e.g., in-line packet processing) of data payloads for one or more data frames sent to or from a host computing device. According to some examples, processor 110 may be a multi-core processor and processor circuits 112-1 to 112-n may be associated with cores of the multi-core processor.

According to some examples, memory controller 114 may be an integrated memory controller for processor 110. In other examples, memory controller 114 may be located separately from processor 110 (e.g., in a chipset—not shown). For either example, memory controller 114 may manage access to memory arrays that may be included at storage 150 or memory 140.

In some examples, as shown in FIG. 1, memory 140 includes buffers 142. Buffers 142 may be arranged to at least temporarily store data that has been processed by or may be processed by one or more of the processor circuits at processor 110. Memory 140 may also provide an operating memory for operating systems and/or software services implemented on processor 110. According to some examples, memory 140 may include at least one or a combination of different types of memory to include random access memory (RAM), dynamic random access memory (DRAM), static RAM (SRAM), phase change material RAM (PRAM), and/or other types of volatile memory.

According to some examples, as shown in FIG. 1, storage 150 includes operating system (OS) 152. OS 152 may be implemented at or by processor circuits 112-1 to 112-n and may be arranged to support a software service as mentioned above. The software service may be modules included in OS 152 or may be separate modules working in cooperation with OS 152. Although not shown in FIG. 1, the separate modules may also be stored or maintained at storage 150. As mentioned more below, OS 152 may support a software service capable of performing packet processing of data payloads for one or more data frames.

In some examples, storage 150 may include various types of memory configured to be implemented or operated in a storage mode of operation. Storage 150 may include at least one or a combination of different types of non-volatile memory storage devices. These different types of storage devices may include, but are not limited to, one or more of a magnetic disk drive, an optical disk drive, a tape drive, an internal storage device, an attached storage device, flash memory, battery backed-up SDRAM (synchronous DRAM), a network accessible storage device, and/or other types of non-volatile memory (e.g., phase change material (PCM)).

According to some examples, as shown in FIG. 1, MAC 120 couples to host computing device 170 via communication link 190 and MAC 130 couples to processor 110 via communication link 125. For these examples, both MAC 120 and MAC 130 may include interfaces to communicatively couple to host computing device 170 and processor 110, respectively, via communications links 170 and 190. In some examples, communication links 170 or 190 may be arranged as data buses. These interfaces included in MAC 120 and MAC 130 may be configured to operate according to various communication protocols associated with industry standards or specifications. One such specification (including progenies and variants) may be a Peripheral Component Interconnect Express (PCI Express) specification such as the PCI Express 3.0 Base Specification, published November 2010. This disclosure is not limited to only PCI Express for MAC 120 or MAC 130 to respectively communicatively couple to host computing device 170 and processor 110, other industry standards or specifications are also contemplated.

In some examples, as shown in FIG. 1, MAC 120 is coupled to MAC 130 via communication link 115. Communication link 115 may be configured to enable MAC 120 to forward data frames received from host computing device 170 to MAC 120. Communication link 115 may also be configured to enable MAC 130 to forward data frames to MAC 120 (e.g., following packet processing of data payloads for the data frames by a software service running at processor circuits 112-1 to 112-n). According to some examples, MAC 120 and MAC 130 may be configured to operate in compliance with an Ethernet specification such as IEEE 802.3, and communication link 115 may also be configured to operate in compliance with the Ethernet standard.

In some examples, as shown in FIG. 1, communication link 135 may couple memory 140 to processor 110. For these examples communication link 135 may include one or more data buses or channels be configured to operate in compliance with one or more standards or specifications such as specifications by the JEDEC Solid State Technology Association. The specifications (including progenies and variants) by the JEDEC Solid State Technology Association may include, but are not limited to, the double data rate type-three (DDR3) synchronous dynamic random access memory (SDRAM) specification, published in June 2007 (“the DDR3 specification”)

In some examples, as shown in FIG. 1, communication link 145 may couple processor 110 to storage 150. For these examples, communication link 145 may be configured to operate according to communication protocols or standards that may be described in one or more industry standards (including progenies and variants) such as those associated with the PCI Express specification, the Universal Serial Bus (USB), specification or the Serial Advanced Technology Attachment (SATA) specification. According to some examples, communication link 145 may be arranged as a data bus to communicatively couple processor 110 to storage 150.

In some examples, host computing device 170 may be included in a computing device. Examples of a computing device may include, but is not limited to, a server, a blade server, a computing board, a desktop computer, a personal computer (PC) or a laptop computer.

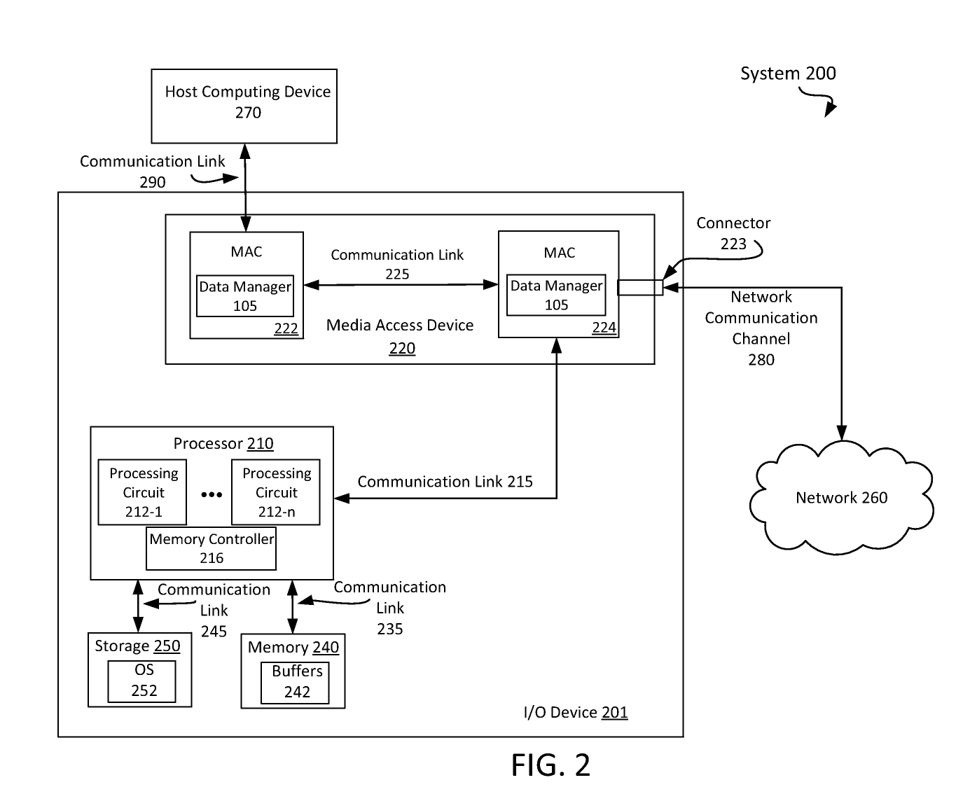

FIG. 2 illustrates an example second system. As shown in FIG. 2, the second system is depicted as system 200. According to some examples, the elements of system 200 shown in FIG. 2 may be similar to the elements of system 100 shown in FIG. 1 with the exception of a media access device 220. As shown in FIG. 2, media access device 220 may be resident on I/O device 201 and may include MAC 222 and MAC 224 capable of being coupled via communication link 225. Also as shown in FIG. 2, media access device 220 also includes a connector 223 through which a network communication channel 280 may be arranged to physically couple to MAC 224.

According to some examples, as shown in FIG. 2, both MAC 222 and MAC 224 may include a data manager 105. As mentioned previously, data manager 105 may include logic and/or features to enable these media access controllers to receive, forward or transmit data frames. The data frames, for example, may have been received either from network 260 or from host computing device 270. In some examples, MAC 222 or MAC 224 may be configured or arranged to operate in compliance with IEEE 802.3 or other types of network related industry standards or specifications.

As shown in FIG. 2, processor 210 having processor circuits 212-1 to 212-n and memory controller 214 may couple to MAC 224 via communication link 215. Also, host computing device 270 may couple to MAC 222 via communication link 290. In some examples, interfaces at MAC 222 and MAC 224, respectively, may be arranged to operate in accordance with the PCI Express specification to enable the media access controllers to communicatively couple to host computing device 270 or processor 210.

According to some examples, as shown in FIG. 2, processor 210 may couple to storage 250 via communication link 245 and couple to memory 240 via communication link 235. Similar to memory 140 shown in FIG. 1, memory 240 includes buffers 242. Also, similar to storage 150 shown in FIG. 1, storage 250 includes an operating system (OS) 252.

In some examples, as mentioned previously, connector 223 may be capable of physically coupling MAC 224 to network communication channel 280. For these examples connector 223 may be configured or arranged according to various industry standards are specification. One such industry standard or specification (including progenies and variants) may be the SFF-8431 Specification for Enhanced Small Form Factor Pluggable Module, Revision 4.1, published July 2009 (“SFP+).

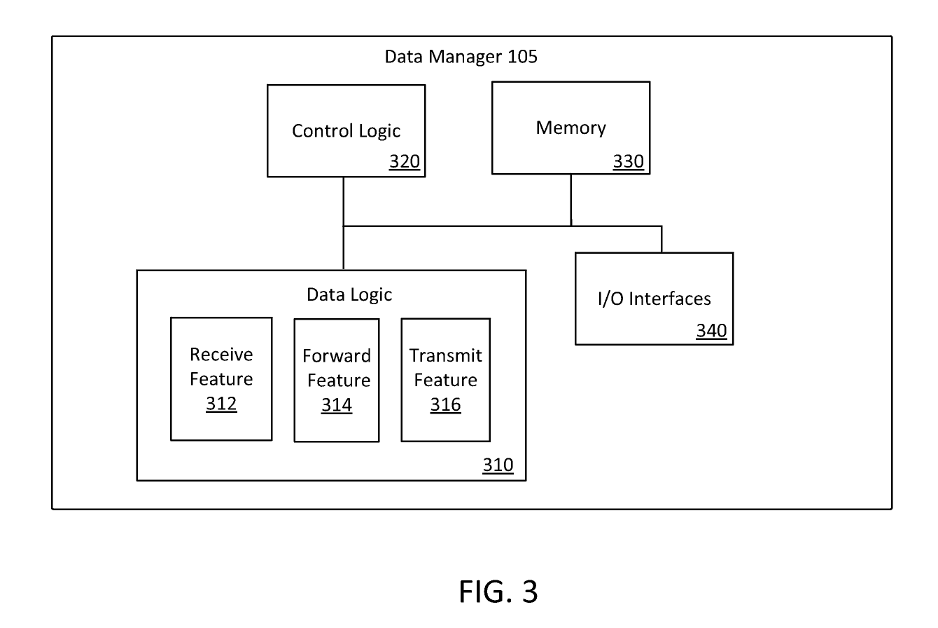

FIG. 3 illustrates a block diagram of an example architecture for data manager 105. In some examples, data manager 105 includes features and/or logic configured or arranged to enable media access controllers at an I/O device to receive, forward or transmit data. According to some examples, as shown in FIG. 3, data manager 105 includes a data logic 310, a control logic 320, a memory 330 and input/output (I/O) interfaces 340. As illustrated in FIG. 3, data logic 310 may be coupled to control logic 320, memory 330 and I/O interfaces 340. Data logic 310 may include one or more of a receive feature 312, a forward feature 314, or a transmit feature 316, or any reasonable combination thereof.

In some examples, the elements portrayed in FIG. 3 are configured to support or enable data manager 105 as described in this disclosure. A given data manager 105 may include some, all or more elements than those depicted in FIG. 3. For example, data logic 310 and control logic 320 may separately or collectively represent a wide variety of logic device(s) or executable content to implement the features of data manager 105. Example logic devices may include one or more of a microprocessor, a microcontroller, a processor circuit, a field programmable gate array (FPGA), an application specific integrated circuit (ASIC), a sequestered thread or a core of a multi-core/multi-threaded microprocessor or a combination thereof.

In some examples, as shown in FIG. 3, data logic 310 includes receive feature 312, forward feature 314, or transmit feature 316. In some examples, these features may separately or collectively represent logic, instructions or executable content. Data logic 310 may be configured to use one or more of these features to perform operations. For example, receive feature 312 may receive a data frame from a host computing device, a network, or from other media access controllers. Forward feature 314 may forward a data frame to another media access controller or to one or more processor circuits for packet processing. Transmit feature 314 may transmit or send data frame to elements at a host computing device or at a network.

In some examples, control logic 320 may be configured to control the overall operation of data manager 105. As mentioned above, control logic 320 may represent any of a wide variety of logic device(s) or executable content. For some examples, control logic 320 may be configured to operate in conjunction with executable content or instructions to implement the control of data manager 105. In some alternate examples, the features and functionality of control logic 320 may be implemented within data logic 310.

According to some examples, memory 330 may be arranged to store executable content or instructions for use by control logic 320 and/or data logic 310. The executable content or instructions may be used to implement or activate features, elements or logic of data manager 105. As described more below, memory 330 may also be arranged to at least temporarily maintain information associated with receiving, forwarding, sending or transmitting one or more data frames.

Memory 330 may include a wide variety of non-volatile memory media including, but not limited to, one or more types of flash memory, programmable variables or states, ROM, RAM, a hard drive or other static or dynamic storage media.

In some examples, I/O interfaces 340 may provide an interface via a local communication medium or link between data manager 105 and elements of a media access controller having or maintaining a data manager 105. I/O interfaces 340 may include interfaces that operate according to various communication protocols or standards to communicate over the local communication medium or link. These communication protocols or standards may be described in one or more industry standards (including progenies and variants) such as those associated with the Inter-Integrated Circuit (I²C) specification, the System Management Bus (SMBus) specification, or the PCI Express specification. Although this disclosure is not limited to only the above-mentioned standards and associated protocols.

According to some examples, I/O interfaces 340 may provide an interface for communication channels or links between data manager 105 and elements located outside of a media access controller. For these examples, I/O interfaces 340 may include interfaces that operate according to various communication protocols or standards to communicate over communication links or channels coupled to the media access controller. These communication protocols or standards may be described in standards or specifications (including progenies and variants) such as the Ethernet specification, the PCI Express specification or the USB specification or other industry standards or specifications for communication protocols.

FIG. 4 illustrates an example third system. As shown in FIG. 4, the third system is depicted as system 400. According to some examples, system 400 includes I/O device 101 coupled to a network 160 via network communication channel 180 and coupled to host computing device 170 via communication link 190. In some examples, as shown in FIG. 4, host computing device 170 may include a virtual machine manager (VMM) 475. VMM 475 may be configured or arranged to manage or control virtual machines (VMs) 472-1 to 472-m (where “m” is any positive integer>2). For these examples, each VM of VMs 472-1 to 472-m may be associated with at least one tenant. For example, VM 472-1 may be associated with tenant 1, VM 472-2 may be associated with tenant 2, etc.

According to some examples, host computing device 170 may be operated by a service provider such as a cloud service provider. For these examples, tenant 1 to tenant m may each have a Service Level Agreement (SLA) via which these tenants may rent or lease computing resources maintained at host computing device 170. These rented computing resources may include the computing resources associated with VMs 472-1 to 472-m.

In some examples, the SLA between a cloud service provider and one or more tenants may include types of software services capable of performing packet processing of data frames originating from or destined to a given tenant. For some examples, a tenant may be identified via meta data in a data frame or by using tenant MAC or Internet Protocol (IP) address or other classification policy defined by a given SLA. The types of software services may include, but are not limited to, a provisioning software service, an isolation software service, a security software service, an identification software service or a metering software service. For these examples, the provisioning software service may indicate how computing resources at host computing device 170 are provisioned between the various tenants. The isolation software service, in some examples, may indicate how one or more data frames may be isolated for security or denial of service attacks. The security software service may indicate security procedures for data frames. The identification software service may indicate ways to identify which tenants can receive/forward data frames. The metering software service may be associated with measuring the amount of data each tenant receives/forwards in data frames in order to determine monetary charges or billings associated with the measured amount of data.

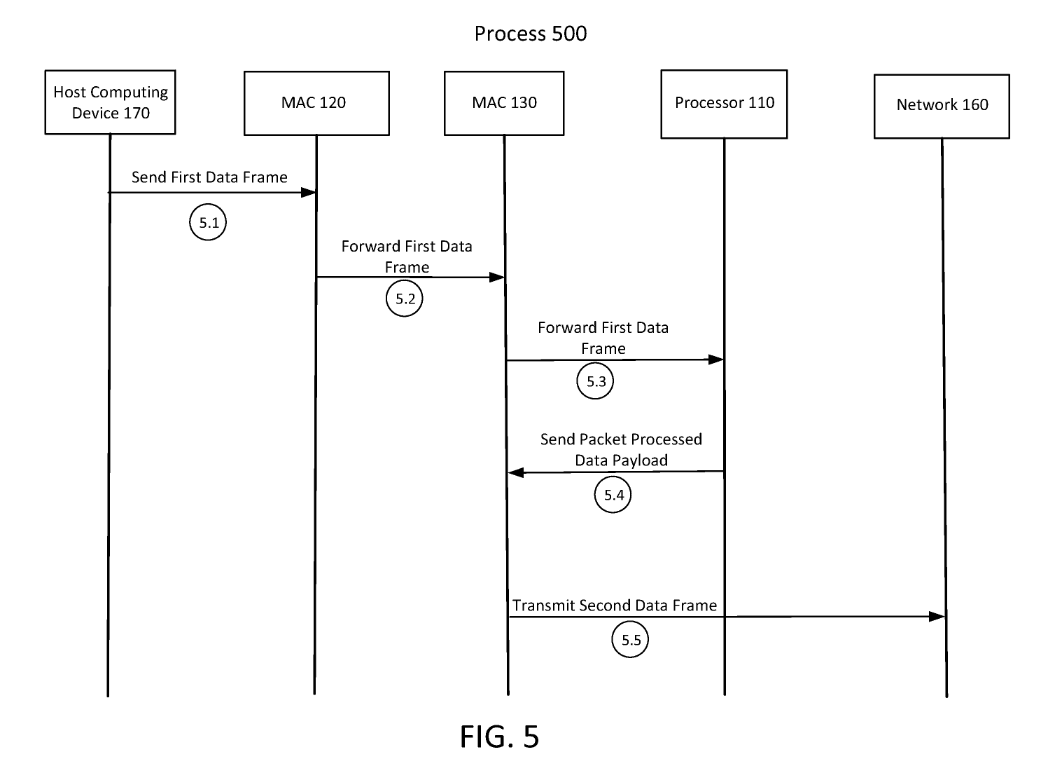

FIG. 5 illustrates an example first process. As shown in FIG. 5, the first process is depicted as process 500. In some examples, process 500 may be for receiving a first data frame from a host computing device coupled to an I/O device. The I/O device may include multiple media access controllers and a processor. The processor may be arranged to implement an operating system arranged to support a software service capable of performing processing of a data payload for the first data frame. For these examples, the processed data payload may be included in a second data frame and transmitted via a communication channel coupled to the I/O device. For these examples, the elements included in systems 100 or 400 as shown in FIG. 1 or 4 or elements included in data manager 105 as shown in FIG. 3 may be used to illustrate example operations related to process 500. The described example operations are not limited to implementations on systems 100 or 400, or to a data manager 105 as described above for FIGS. 1, 3 and 4.

Beginning at process 5.1 (Send First Data Frame), host computing device 170 may forward a first data frame to media access controller (MAC) 120 included in I/O device 101 via communication link 190. In some examples, the forwarded first data frame may be received by logic and/or features of data manager 105 (e.g., receive feature 312). For these examples, the first data frame may have originated from VM 472-1 associated with tenant 1 and the first data frame may have a destination associated with network 160.

Proceeding to process 5.2 (Forward First Data Frame), data manager 105 at MAC 120 may include logic and/or features to forward the first data frame to MAC 130 via communication link 115 (e.g., via forward feature 314). In some examples, both MAC 120 and MAC 130 may be arranged to operate according to an Ethernet specification such as IEEE 802.3. For these examples, the first data frame may be forwarded as an Ethernet frame over communication link 115.

Proceeding to process 5.3 (Forward First Data Frame), data manager 105 at MAC 130 may include logic and/or features arranged to receive the first data frame (e.g., via receive feature 312) forwarded from MAC 120 and also arranged to forward the first data frame to processor 110 (e.g., via forward feature 314) via communication channel 125.

Proceeding to process 5.4 (Send packet processed Data Payload), following packet processing of a data payload for the first data frame, processor circuit 112-1 to 112-n may send packet processed payload data to MAC 130. In some examples, this may include processor circuits 112-1 to 112-n arranged to implement OS 152 that may be arranged to support a software service capable of performing the packet processing of the data payload. For these examples, the software service may be associated with a Service Level Agreement (SLA) between tenant 1 and a service provider operating host computing device 170. The SLA may include one or more of a provisioning software service, an isolation software service, a security software service, an identification software service or a metering software service.

Proceeding to process 5.5 (Transmit Second Data Frame), data manager 105 at MAC 130 may include logic and/or features to receive the packet processed data payload from processor 110 (e.g., via receive feature 312) and to transmit this processed data payload in a second data frame to network 160 (e.g., via transmit feature 316). In some examples, data manager 105 may transmit the second data frame in a format determined by an applicable communication protocol via which communication channel 180 is arranged to operate. For example, communication channel 180 may be arranged to operate according to an Ethernet specification such as IEEE 802.3. The second data frame may then be formatted in an IEEE 802.3 compliant format and then transmitted to network 160 via communication channel 180.

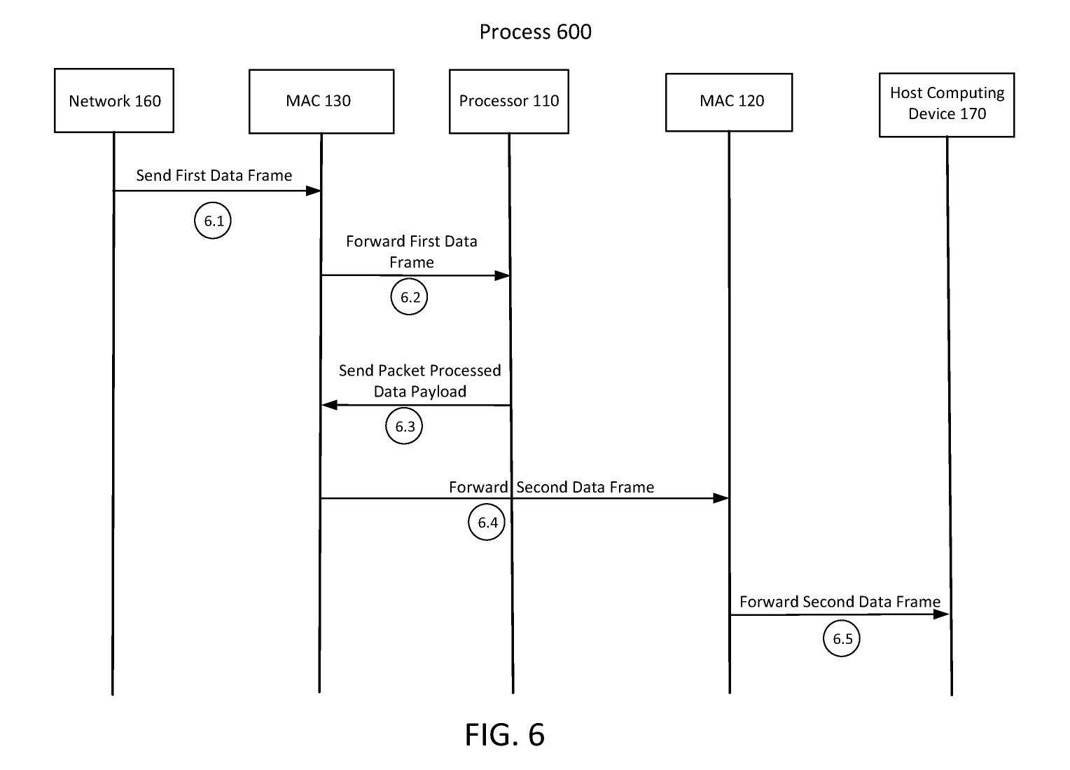

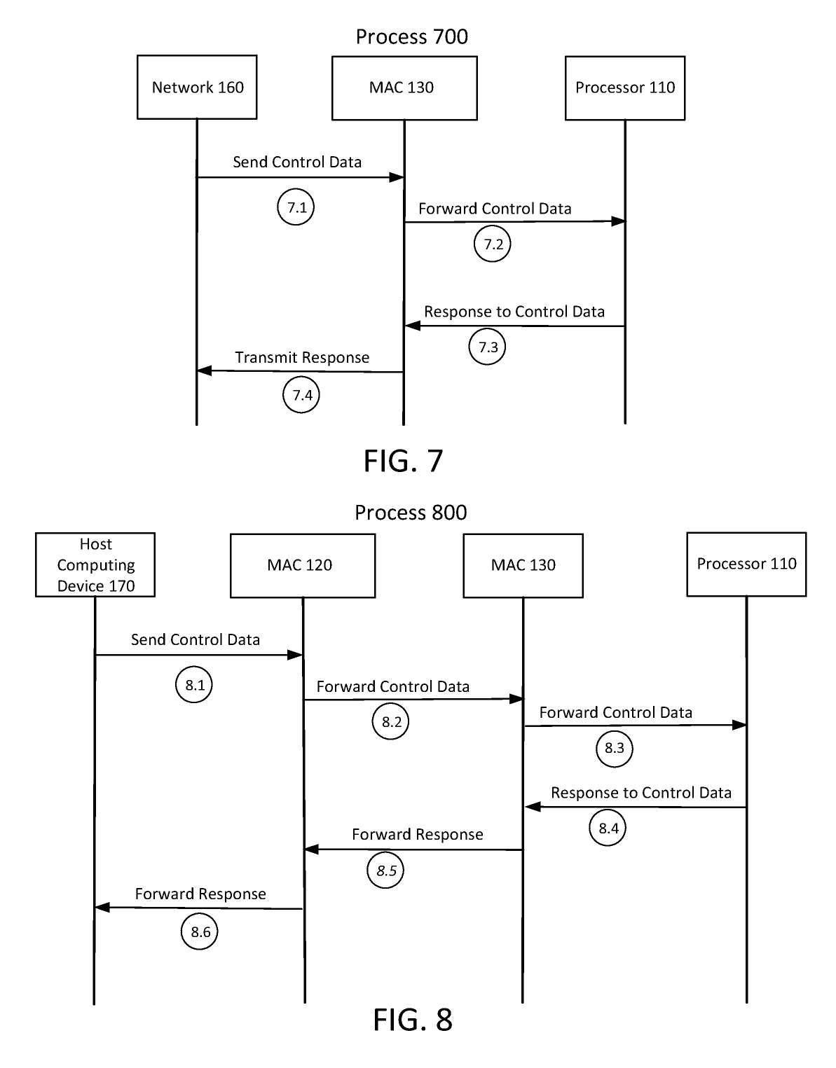

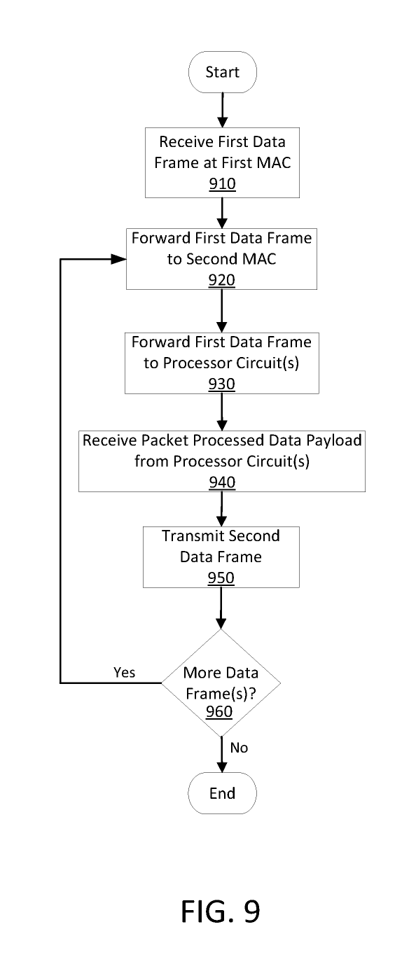

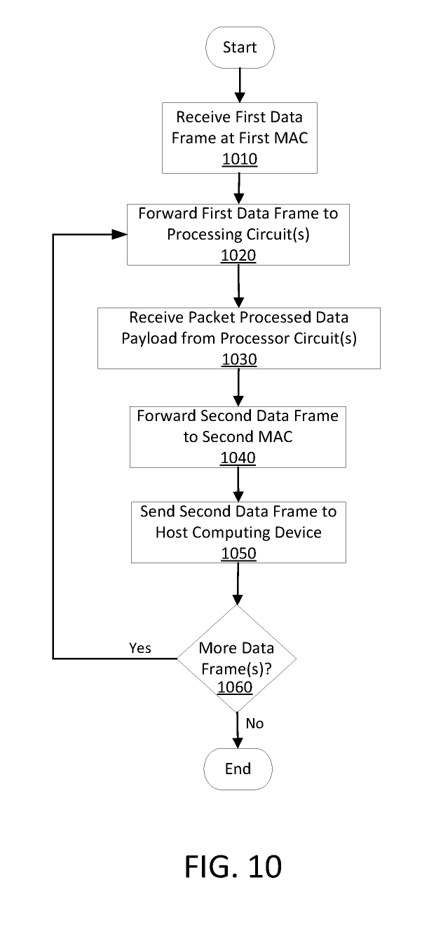

FIG. 6 illustrates an example second process. As shown in FIG. 6, the second process is depicted as process 600. In some examples, process 600 may be for receiving a first data frame destined for a host computing device from a network coupled to a I/O device via a network communication channel. The I/O device may include multiple media access controllers and a processor arranged to implement an operating system arranged to support a software service capable of performing processing of a data payload for the first data frame. For these examples, the d processed data payload may be included in a second data frame and forwarded to the host computing device. For these examples, the elements included in systems 100 or 400 as shown in FIG. 1 or 4 or elements included in data manager 105 as shown in FIG. 3 may be used to illustrate example operations related to process 600. The described example operations are not limited to implementations on systems 100 or 400, or to a data manager 105 as described above for FIGS. 1, 3 and 4.

Beginning at process 6.1 (Send First Data Frame), network 160 may send a first data frame destined for host computing device 170. In some examples, MAC 130 included in I/O device 101 may receive the first data frame on behalf of host computing device 170. For these examples, MAC 130 may be coupled to network 160 via communication channel 180. A data manager 105 at MAC 130 may include logic and/or features to receive the first data frame (e.g., via receive feature 312). The first data frame, for example, may be destined for VM 472-2 associated with tenant 2. Tenant 2, for example, may have an SLA with a service provider operating host computing device 170.

Proceeding to process 6.2 (Forward First Data Frame), data manager 105 at MAC 130 may include logic and/or features to forward the first data frame to processor 110 via communication link 115 (e.g., via forward feature 314).

Proceeding to process 6.3 (Send packet processed Data Payload), a software service running at processor 110 may be arranged to perform packet processing of a data payload for the first data frame forwarded from MAC 130. In some examples, as shown in FIG. 6, the packet processed data payload may then be sent back to MAC 130. For these examples, OS 152 may be arranged to support the software service arranged to perform packet processing of a data payload for the first data frame. The software service may be associated with the SLA between tenant 2 and the service provider. The SLA may include one or more of a provisioning software service, an isolation software service, a security software service, an identification software service or a metering software service.

Proceeding to process 6.4 (Forward Second Data Frame), data manager 105 at MAC 130 may include logic and/or features arranged to receive the packet processed data payload from processor 110 (e.g., via receive feature 312) and also arranged to forward the packet processed data payload to MAC 120 via communication link 115 (e.g., via forward feature 314) in a second data frame. In some examples, both MAC 130 and MAC 120 may be arranged to operate according to IEEE 802.3. For these examples, the packet processed data payload may be forwarded in the second data frame in the format of an Ethernet frame over communication link 115.

Proceeding to process 6.5 (Forward Second Data Frame), data manager 105 at MAC 120 may include logic and/or features to receive the second data frame from MAC 130 (e.g., via receive feature 312) and to forward the second data frame to host computing device 170 via communication link 170 (e.g., via forward feature 314). In some examples, data manager 105 may forward the second data frame to VMM 475 and then VMM 475 may relay the second data frame to VM 472-2 associated with tenant 2. In some other examples, data manager 105 may directly forward the second data frame to VM 472-2.

FIG. 7 illustrates an example third process. As shown in FIG. 7, the third process is depicted as process 700. In some examples, process 700 may be for receiving control data via a network communication channel that may configure elements of an I/O device (e.g., a software service running on a processor) coupled to the communication channel. The I/O device may include multiple media access controllers and a processor. The processor may be arranged to implement an operating system arranged to support a software service capable of performing processing of a data payload for a data frame. For these examples, the elements included in systems 100 or 400 as shown in FIG. 1 or 4 or elements included in data manager 105 as shown in FIG. 3 may be used to illustrate example operations related to process 700. The described example operations are not limited to implementations on systems 100 or 400, or to a data manager 105 as described above for FIGS. 1, 3 and 4.

Beginning at process 7.1 (Send Control Data), control data may be sent from an element associated with network 160 (e.g., a fabric manager). In some examples, the control data may be destined for host computing device 170 based on the network element's expectation that a software service running at a processor at the host computing devise 170 rather running at processor 110 at I/O device 101 is to be configured for processing network related data. For these examples, MAC 130 may be coupled to the network element via communication channel 180. A data manager 105 at MAC 130 may include logic and/or features to receive the control data (e.g., via receive feature 312).

Proceeding to process 7.2 (Forward Control Data), data manager 105 at MAC 130 may include logic and/or features to forward the control data to elements at processor 110 via communication link 125 (e.g., via forward feature 314).

Proceeding to process 7.3 (Response to Control Data), OS 152 implemented by processor circuits 112-1 to 112-n at processor 110 may configure or arrange the software service according to the control data and then send a response to indicate a status of the configuration (e.g., complete, failure, pending, etc.). In some examples, the response to the control data may be sent via communication link 125 to MAC 130.

Proceeding to process 7.4 (Transmit Response), data manager 105 at MAC 130 may include logic and/or features to transmit the response to the network elements at network 160 (e.g., via transmit feature 316). For these examples, the response may be formatted in an IEEE 802.3 compliant format for transmission to network 160 via network communication channel 180.

FIG. 8 illustrates an example fourth process. As shown in FIG. 8, the third process is depicted as process 800. In some examples, process 800 may be for receiving control data from elements at a host computing device (e.g., a VMM) in order to configure elements of an I/O device (e.g., a software service running on a processor) coupled to the host computing device. The I/O device may include multiple media access controllers and a processor. The processor may be arranged to implement an operating system arranged to support a software service capable of performing processing of a data payload for a data frame. For these examples, the elements included in systems 100 or 400 as shown in FIG. 1 or 4 or elements included in data manager 105 as shown in FIG. 3 may be used to illustrate example operations related to process 800. The described example operations are not limited to implementations on systems 100 or 400, or to a data manager 105 as described above for FIGS. 1, 3 and 4.

Beginning at process 8.1 (Send Control Data), control data may be sent from an element associated with host computing device 170 such as VMM 475. In some examples VMM 475 may have sent the control data in order to configure a software service at processor 110 for processing data payloads for data frames received from VMs 472-1 to 472-m. For these examples, MAC 120 may be communicatively coupled to VMM 475 at host computing device 170 via communication link 190. A data manager 105 at MAC 120 may include logic and/or features to receive the control data (e.g., via receive feature 312).

Proceeding to process 8.2 (Forward Control Data), data manager 105 at MAC 120 may include logic and/or features to forward the control data to MAC 130 via communication link 115 (e.g., via forward feature 314).

Proceeding to process 8.3 (Forward Control Data), data manager 105 at MAC 130 may also include logic and/or features to receive the control data and then to forward the control data via communication channel 125 to the software service running at processor 110.

Proceeding to process 8.4 (Response to Control Data), OS 152 implemented by processor circuits 112-1 to 112-n at processor 110 may configure or arrange the software service according to the control data and then send a response to indicate a status of the configuration (e.g., complete, failure, pending, etc.). In some examples, the response to the control data may be sent via communication link 125 to MAC 130.

Proceeding to process 8.5 (Forward Response), data manager 105 at MAC 130 may include logic and/or features to receive the response (e.g., via receive feature 312) and then to forward the response (e.g., via forward feature 314) via communication channel 115 to MAC 120.

Proceeding to process 8.6 (Forward Response), data manager 105 at MAC 120 may also include logic and/or features to receive the response and forward the response to VMM 475 at host computing device 170 via communication link 190.

FIG. 9 illustrates an example flow diagram for receiving a data frame from a host computing device. In some examples, elements of systems 100, 200 or 400 as shown in FIGS. 1, 2 and 4 may be used to illustrate example operations related to the flow chart depicted in FIG. 9. Data manager 105 as shown in FIG. 1 or FIG. 3 may also be used to illustrate the example operations. But the described example operations are not limited to implementations on systems 100, 200 or 400, or data manager 105.

Moving from the start to block 910 (Receive First Data Frame at First MAC), data manager 105 at MAC 120 may include logic and/or features arranged to receive a first data frame from host computing device 170 via communication link 190 (e.g., via receive feature 312). In some examples, the first data frame may have originated from VM 472-2 associated with tenant 2 and the first data frame may have a destination associated with network 160.

Proceeding from block 910 to block 920 (Forward First Data Frame to Second MAC), data manager 105 at MAC 120 may include logic and/or features arranged to forward the first data frame to MAC 130 (e.g., via forward feature 314). In some examples, the first data frame may be forwarded via communication link 115.

Proceeding from block 920 to block 930 (Forward First Data Frame to Processor circuit(s)), data manager 105 at MAC 130 may include logic and/or features arranged to receive the first data frame over communication link 115 (e.g., via receive feature 312) and also arranged to forward the first data frame to processor circuits 112-1 to 112-n at processor 110 (e.g., via forward feature 314). In some examples, the first data frame may be forwarded to processor circuits 112-1 to 112-n via communication link 125. For these examples, one or more processor circuits 112-1 to 112-n at processor 110 may be arranged to implement OS 152 that may be arranged to support a software service capable of performing packet processing of a data payload for the first data frame. The software service may perform the packet processing of the data payload according to an SLA between tenant 2 and a service provider operating host computing device 170.

Moving from block 930 to block 940 (Receive packet processed Data Payload from Processor circuit(s)), data manager 105 at MAC 130 may include logic and/or features arranged to receive (e.g., via receive feature 312) the packet processed data payload from processor circuits 112-1 to 112-n.

Moving from block 940 to block 950 (Transmit Second Data Frame), data manager 105 at MAC 130 may include logic and/or features arranged to include the packet processed data payload in a second data frame (e.g., via transmit feature 316) and transmit the second data frame towards the destination associated with network 160. In some examples, the second data frame may be transmitted via communication channel 180 coupled to network 160.

Moving from block 950 to decision block 960 (More Data Frame(s)?), data manager 105 at MAC 120 may determine if additional data frames needs to be forwarded to MAC 130. If more data frames are received from host computing device 170 (e.g., from tenant 2), the process moves to block 920. Otherwise, the process comes to an end.

FIG. 10 an example flow diagram for receiving a data frame via a network communication channel. In some examples, elements of systems 100, 200 or 400 as shown in FIGS. 1, 2 and 4 may be used to illustrate example operations related to the flow chart depicted in FIG. 10. Data manager 105 as shown in FIG. 1 or FIG. 3 may also be used to illustrate the example operations. But the described example operations are not limited to implementations on systems 100, 200 or 400, or data manager 105.

Moving from the start to block 1010 (Receive First Data Frame at First MAC), data manager 105 at MAC 130 may include logic and/or features arranged to receive a first data frame destined for host computing device 170 from network 160 via communication link 190 (e.g., via receive feature 312). In some examples, the first data frame may be destined for VM 472-1 associated with tenant 1.

Proceeding from block 1010 to block 1020 (Forward First Data Frame to Processor circuit(s)), data manager 105 at MAC 130 may include logic and/or features arranged to forward the first data frame to processor circuits 112-1 to 112-n at processor 110 (e.g., via forward feature 314). In some examples, the first data frame may be forwarded to processor circuits 112-1 to 112-n via communication link 125. For these examples, one or more processor circuits 112-1 to 112-n at processor 110 may be arranged to implement OS 152 that may be arranged to support a software service capable of performing packet processing of a data payload for the first data frame. The software service may perform the packet processing of the data payload according to an SLA between tenant 1 and a service provider operating host computing device 170.

Proceeding from block 1020 to block 1030 (Receive packet processed Data Payload from Processor circuit(s)), data manager 105 at MAC 130 may include logic and/or features arranged to receive (e.g., via receive feature 312) the packet processed data payload from processor circuits 112-1 to 112-n.

Proceeding from block 1030 to block 1040 (Forward Second Data Frame to Second MAC), data manager 105 at MAC 130 may include logic and/or features arranged to include the packet processed data payload in a second data frame and forward the second data frame to MAC 120 (e.g., via forward feature 314). In some examples, the second data frame may be forwarded via communication link 115.

Moving from block 1040 to block 1050 (Send Second Data Frame to Host computing device), data manager 105 at MAC 120 may include logic and/or features arranged to send the second data frame (e.g., via transmit feature 316) towards the VM 472-1 associated with tenant 1 at host computing device 170. In some examples, the second data frame may be sent via communication channel 180 coupled to host computing device 170.

Moving from block 1050 to decision block 1060 (More Data Frame(s)?), data manager 105 at MAC 130 may determine if additional data frames need to be forwarded to processors 112-1 to 112-n for packet processing of associated data payloads. If more data frames need to be forwarded, the process moves to block 1020. Otherwise, the process comes to an end.

One or more aspects of at least one example may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture. An article of manufacture may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof.

According to some examples, an article of manufacture may include a non-transitory storage medium to store or maintain instructions that when executed by a computer or system, cause the computer or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a computer to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

According to some examples, a first apparatus or first device may include a first media access controller capable of being coupled to a network communication channel and a second media access controller capable of being coupled to a host computing device. The first device may also include one or more processor circuits arranged to perform packet processing of data payloads for one or more data frames forwarded through the second media access controller and/or forwarded through the first media access controller. For these examples, a first communication link may couple the first media access controller to the second media access controller and a second communication link may couple the first media access controller to the one or more processor circuits.

In some examples, the first device may also include a memory coupled to the one or more processor circuits. The memory may be arranged to at least temporarily store data payloads received at the first media access controller from the network communication channel in one or more data frames or configured to at least temporarily store data payloads received at the second media access controller from the host computing device in one or more data frames. The memory may include volatile memory.

In some examples, the one or more processor circuits included in the first device may also be arranged to perform tasks associated with packet processing to include executing an operating system to support a software service that facilitates packet processing of the data payloads for the one or more data frames.

According to some examples, the first communication link included in the first device may be arranged to enable the first media access controller to forward a packet processed data payload for a data frame to the second media access controller. Also, the data frame may be received at the first media access controller from the network communication channel. The received data frame may be forwarded to the one or more processor circuits by the first media access controller via the second communication link in order for the data payload to become packet processed data by the software service.

In some examples, the first communication link included in the first device may be configured to enable the second media access controller to forward a first data frame to the first media access controller. The first data frame may have been received from the host computing device. The first media access controller may be arranged to receive the forwarded first data frame via the first communication link and send the forwarded first data frame to the one or more processor circuits via the second communication link for packet processing of a data payload for the first data frame by the software service. The first media access controller may also be arranged to transmit the packet processed data payload for the first data frame in a second data frame via the network communication channel.

According to some examples, the first media access controller included in the first device may function as a network input/output device for the host computing device from a perspective of a network associated with the network communication channel. The second media access controller included in the first device may function as the network input/output device from the perspective of the host computing device.

In some examples, the software service may include at least one of a provisioning software service, an isolation software service, a security software service, an identification software service or a metering software service. The software service may be based on one or more Service Level Agreements between a service provider arranged to operate the host computing device and one or more tenants arranged to utilize computing resources maintained at the host computing device. According to some examples, the one or more tenants may be arranged to utilize the computing resources by being separately configured as one or more virtual machines that may be arranged to utilize the computing resources maintained at the host computing device.

According to some examples, the first media access controller or the second media access controller included in the first device may be arranged to operate in compliance with an Ethernet specification. The Ethernet specification may include IEEE 802.3.

According to some examples, the first media access controller included in the first device may be arranged to couple to the second communication link via a first interface. Also, the second media access controller included in the first device may be arranged to couple to the host computing device via a second interface. For these examples, both the first interface and the second interface may be arranged to operate in compliance with the PCI Express specification.

In some examples, the one or more processor circuits included in the first device may include one or more cores of a multi-core processor.

According to some examples, a second apparatus or second device may include a first media access controller capable of being coupled to a host computing device and a second media access controller capable of being coupled to one or more processor circuits and also capable of being coupled to a network communication channel. The one or more processor circuits may be arranged to perform packet processing of data payloads for one or more data frames forwarded through the first media access controller and/or to or forwarded through the second media access controller. In some examples, the second apparatus may also include a communication link arranged to couple the first media access controller to the second media access controller.

In some examples, the second device may also include a connector arranged to physically couple the second media access controller to the network communication channel.

In some examples, the one or more processor circuits included in the second device may also be arranged to perform tasks associated with packet processing to include executing an operating system to support a software service that facilitates packet processing of the data payloads for the one or more data frames.

According to some examples, the communication link included in the second device may be arranged to enable the second media access controller to forward a packet processed data payload for a data frame to the first media access controller. For these examples, the data frame may have been received at the second media access controller from the network communication channel. The received data frame may have been forwarded to the one or more processor circuits by the second media access controller in order for the data payload to become packet processed data by the software service.

In some examples, the communication link included in the second device may be arranged to enable the first media access controller to forward a first data frame to the second media access controller. For these examples, the first data frame may have been received from the host computing device. The second media access controller may be arranged to receive the first data frame and send the first data frame to the one or more processor circuits for packet processing of a data payload for the first data frame by the software service. The second media access controller may also be arranged to transmit the packet processed data payload for the first data frame in a second data frame via the network communication channel.

According to some examples, the second media access controller included in the second device may be arranged to function as a network input/output device for the host computing device from a perspective of a network associated with the network communication channel. For these examples, the first media access controller included in the second device may be arranged to function as the network input/output device from the perspective of the host computing device.

In some examples, the first media access controller or the second media access controller included in the second device may each be arranged to operate in compliance with an Ethernet specification. For these examples, the Ethernet specification may include IEEE 802.3.

According to some examples, the second media access controller included in the second device may be capable of being coupled to the one or more processor circuits via a second interface. Also, the first media access controller included in the second device may be capable of being coupled to the host computing device via a first interface. For these examples, both the first interface and the second interface may be arranged to operate in compliance with the PCI Express specification.

In some examples a first method may be implemented. The implementing the first method may include receiving a first data frame at a first media access controller from a host computing device coupled to the first media access controller. The first data frame may then be forwarded to a second media access controller via a first communication link coupling the second media access controller to the first media access controller. The first data frame may then be received at the second media access controller and then forwarded to one or more processor circuits via a second communication link. The one or more processor circuits may be arranged to perform packet processing of a data payload for the first data frame. The packet processed data payload may then be received at the second media access controller via the first communication link. The packet processed data payload may be included in a second data frame and then the second data frame may be transmitted from the second media access controller via a network communication channel coupled to the second media access controller.

According to some examples, for implementing the first method, the one or more processor circuits may also be arranged to perform tasks associated with packet processing to include executing an operating system to support a software service that facilitates packet processing of the data payloads for the one or more data frames.

According to some examples, for implementing the first method, the software service may be based on one or more Service Level Agreements between a service provider arranged to operate the host computing device and one or more tenants arranged to utilize computing resources maintained at the host computing device. The software service may include at least one of a provisioning software service, an isolation software service, a security software service, an identification software service or a metering software service. Also, the one or more tenants may be separately configured as one or more virtual machines arranged to utilize the computing resources maintained at the host computing device.

In some examples, for implementing the first method, the first media access controller or the second media access controller may be operated in compliance with an Ethernet specification to implement the first method. The Ethernet specification may include IEEE 802.3.

In some examples a second method may be implemented. The implementing the second method may include receiving a first data frame at a first media access controller coupled to a network communication channel. The first data frame destined for a host computing device coupled to a second media access controller. The first data frame may then be forwarded one or more processor circuits via a first communication link. The one or more processor circuits may be arranged to perform packet processing of a data payload for the first data frame. For these examples, the data payload may be received from the one or more processor circuits at the first media access controller via the first communication link. The packet processed data payload may then be included in a second data frame. The second data frame may then be forwarded to the second media access controller via a second communication link coupling the first media access controller to the second media access controller. The second data frame may then be received at the second media access controller and then sent to the host computing from the second media access controller.

According to some examples, for implementing the second method, the one or more processor circuits may also be arranged to perform tasks associated with packet processing to include executing an operating system to support a software service that facilitates packet processing of the data payloads for the one or more data frames.

According to some examples, for implementing the second method, the software service may be based on one or more Service Level Agreements between a service provider arranged to operate the host computing device and one or more tenants arranged to utilize computing resources maintained at the host computing device. The software service may include at least one of a provisioning software service, an isolation software service, a security software service, an identification software service or a metering software service. Also, the one or more tenants may be separately configured as one or more virtual machines arranged to utilize the computing resources maintained at the host computing device.

In some examples, for implementing the second method, the first media access controller or the second media access controller may be operated in compliance with an Ethernet specification to implement the first method. The Ethernet specification may include IEEE 802.3.

According to some examples, at least one machine readable medium comprising a plurality of instructions that in response to being executed on a computing device cause the computing device to carry out the first method or the second method as mentioned above.

In some examples an apparatus or device may include means for performing the first method or the second method as mentioned above.

In some examples a communication device may be arranged to perform the first method or the second method as mentioned above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus comprising:
a first media access controller capable of being coupled to a network communication channel;
a second media access controller capable of being coupled to a host computing device;
one or more processor circuits arranged to perform processing of data payloads for one or more data frames forwarded through the second media access controller and/or forwarded through the first media access controller;
a first communication link to couple the first media access controller to the second media access controller; and
a second communication link to couple the first media access controller to the one or more processor circuits.

2. The apparatus of claim 1, comprising memory coupled to the one or more processor circuits, the memory arranged to at least temporarily store data payloads received at the first media access controller from the network communication channel in one or more data frames or arranged to at least temporarily store data payloads received at the second media access controller from the host computing device in one or more data frames.

3. The apparatus of claim 2, comprising the memory to include volatile memory.

4. The apparatus of claim 1, comprising, the one or more processor circuits also arranged to perform tasks associated with packet processing to include executing an operating system to support a software service that facilitates packet processing of the data payloads for the one or more data frames.

5. The apparatus of claim 4, comprising the first communication link arranged to enable the first media access controller to forward a packet processed data payload for a data frame to the second media access controller, the data frame received at the first media access controller from the network communication channel, the received data frame forwarded to the one or more processor circuits by the first media access controller via the second communication link in order for the data payload to become packet processed by the software service.

6. The apparatus of claim 4, comprising the first communication link arranged to enable the second media access controller to forward a first data frame to the first media access controller, the first data frame received from the host computing device, the first media access controller arranged to receive the first data frame via the first communication link and send the first data frame to the one or more processor circuits via the second communication link for packet processing of a data payload for the first data frame by the software service, the first media access controller also arranged to transmit the packet processed data payload for the first data frame in a second data frame via the network communication channel.

7. The apparatus of claim 4, comprising the software service to include at least one of a provisioning software service, an isolation software service, a security software service, an identification software service or a metering software service.

8. The apparatus of claim 7, the software service based on one or more Service Level Agreements between a service provider arranged to operate the host computing device and one or more tenants arranged to utilize computing resources maintained at the host computing device.

9. The apparatus of claim 8, the one or more tenants separately configured as one or more virtual machines arranged to utilize the computing resources maintained at the host computing device.

10. The apparatus of claim 1, comprising the first media access controller to function as a network input/output device for the host computing device from a perspective of a network associated with the network communication channel and the second media access controller to function as the network input/output device from the perspective of the host computing device.

11. The apparatus of claim 1, comprising the first media access controller or the second media access controller arranged to operate in compliance with an Ethernet specification to include an Institute of Electrical and Electronics Engineers (IEEE) 802.3 Ethernet specification.

12. The apparatus of claim 1, comprising the first media access controller arranged to couple to the second communication link via a first interface and the second media access controller arranged to couple to the host computing device via a second interface, both the first interface and the second interface arranged to operate in compliance with a Peripheral Component Interconnect Express (PCI Express) specification.

13. The apparatus of claim 1, the one or more processor circuits to include one or more cores of a multi-core processor.

14. An apparatus comprising:
a first media access controller capable of being coupled to a host computing device;
a second media access controller capable of being coupled to one or more processor circuits and also capable of being coupled to a network communication channel, the one or more processor circuits arranged to perform packet processing of data payloads for one or more data frames forwarded through the first media access controller and/or forwarded through the second media access controller; and
a communication link arranged to couple the first media access controller to the second media access controller.

15. The apparatus of claim 14, comprising a connector arranged to physically couple the second media access controller to the network communication channel.

16. The apparatus of claim 14, comprising the one or more processor circuits also arranged to perform tasks associated with processing to include executing an operating system to support a software service that facilitates packet processing of the data payloads for the one or more data frames.

17. The apparatus of claim 16, comprising the communication link arranged to enable the second media access controller to forward a packet processed data payload for a data frame to the first media access controller, the data frame received at the second media access controller from the network communication channel, the received data frame forwarded to the one or more processor circuits by the second media access controller in order for the data payload to become packet processed by the software service.

18. The apparatus of claim 16, comprising the communication link arranged to enable the first media access controller to forward a first data frame to the second media access controller, the first data frame received from the host computing device, the second media access controller arranged to receive the first data frame and send the first data frame to the one or more processor circuits for packet processing of a data payload for the first data frame by the software service, the second media access controller also arranged to transmit the packet processed data payload for the first data frame in a second data frame via the network communication channel.

19. The apparatus of claim 14, comprising the second media access controller arranged to function as a network input/output device for the host computing device from a perspective of a network associated with the network communication channel and the first media access controller arranged to function as the network input/output device from the perspective of the host computing device.

20. (canceled)

21. (canceled)

22. A method comprising:
receiving a first data frame at a first media access controller, the first data frame received from a host computing device coupled to the first media access controller;
forwarding the first data frame to a second media access controller via a first communication link coupling the second media access controller to the first media access controller;
receiving the first data frame at the second media access controller and forwarding the first data frame to one or more processor circuits via a second communication link, the one or more processor circuits arranged to perform packet processing of a data payload for the first data frame;
receiving, at the second media access controller via the first communication link, the packet processed data payload from the one or more processor circuits and including the packet processed data payload in a second data frame; and
transmitting the second data frame from the second media access controller via a network communication channel coupled to the second media access controller.

23. The method of claim 22, comprising the one or more processor circuits also arranged to perform tasks associated with processing to include executing an operating system to support a software service that facilitates packet processing of the data payloads for the one or more data frames.

24. The method of claim 23, comprising the software service being based on one or more Service Level Agreements between a service provider arranged to operate the host computing device and one or more tenants arranged to utilize computing resources maintained at the host computing device.

25. The method of claim 24, comprising the service to include at least one of a provisioning software service, an isolation software service, a security software service, an identification software service or a metering software service.

26. The method of claim 24, comprising the one or more tenants separately configured as one or more virtual machines arranged to utilize the computing resources maintained at the host computing device.

27. The method of claim 23, comprising operating the first media access controller or the second media access controller in compliance with an Ethernet specification to include an Institute of Electrical and Electronics Engineers (IEEE) 802.3 Ethernet specification.

28. (canceled)

29. A method comprising:
receiving a first data frame at a first media access controller coupled to a network communication channel, the first data frame destined for a host computing device coupled to a second media access controller;
forwarding the first data frame to one or more processor circuits via a first communication link, the one or more processor circuits arranged to perform packet processing of a data payload for the first data frame;
receiving, at the first media access controller via the first communication link, the data payload from the one or more processor circuits after packet processing and including the packet processed data payload in a second data frame;
forwarding the second data frame to the second media access controller via a second communication link coupling the first media access controller to the second media access controller;
receiving the second data frame at the second media access controller; and
sending the second data frame from the second media access controller to the host computing device.

30. The method of claim 29, comprising the one or more processor circuits also arranged to perform tasks associated with processing to include executing an operating system to support a software service that facilitates packet processing of the data payloads for the one or more data frames.

31. The method of claim 30, comprising the software service being based on one or more Service Level Agreements between a service provider arranged to operate the host computing device and one or more tenants arranged to utilize computing resources maintained at the host computing device.

32. The method of claim 31, comprising the software service to include at least one of a provisioning software service, an isolation software service, a security software service, an identification software service or a metering software service.

33. The method of claim 31, comprising the one or more tenants separately configured as one or more virtual machines arranged to utilize the computing resources maintained at the host computing device.

34. (canceled)

35. (canceled)

36. (canceled)

37. (canceled)

38. (canceled)

39. (canceled)
